(19) United States
(12) Patent Application Publication
(10) Pub. No.: US 2026/0369824 A1
(43) Pub. Date: Nov. 19, 2026

(54) BATTERY CELL CAP ATTACHMENT

(71) Applicant: GM Global Technology Operations LLC, Detroit, MI (US)

(72) Inventors: Matthew Arthur Celentano, Berkley, MI (US); Kiran Raju G, Bangalore (IN); Joseph Slabbert, Rochester Hills, MI (US); Sriniket Achar, Sterling Heights, MI (US); Junjie Ma, Novi, MI (US)

(21) Appl. No.: 19/210,203

(22) Filed: May 16, 2025

(51) Int. Cl. H01M 50/528; H01M 50/54; H01M 50/552; H01M 50/566

(52) U.S. Cl. CPC H01M 50/528; H01M 50/54; H01M 50/552; H01M 50/566

(57) ABSTRACT

A battery cell including a sandwich bar securing and interconnecting a plurality of electrode tabs and including a welded joint that fuses the plurality of electrode tabs to the sandwich bar, the welded joint extending upward beyond a top surface of the sandwich bar, and a battery terminal electrically connected, via a weld, to the sandwich bar.

### INTRODUCTION

The present invention relates generally to electrochemical energy storage devices such as Li-ion batteries, and more particularly to a method of attaching a battery terminal to a sandwich bar of a battery cell.

Current manufacturing processes for prismatic battery cells require minimum electrode lengths of approximately. Thus, while current battery cells and manufacturing methods achieve their intended purpose, there is a need for a new and improved battery cell and method of attaching a battery terminal to a sandwich bar of the battery cell that enables use of electrodes having shorter length.

### SUMMARY

According to several aspects of the present disclosure, a battery cell includes a sandwich bar securing and interconnecting a plurality of electrode tabs and including a welded joint that fuses the plurality of electrode tabs to the sandwich bar, the welded joint extending upward beyond a top surface of the sandwich bar, and a battery terminal electrically connected, via a weld, to the sandwich bar.

According to another aspect, the battery terminal includes a recess formed within a bottom surface thereof, and the battery terminal is positioned onto the sandwich bar, wherein the welded joint is received within the recess and the bottom surface of the battery terminal is in direct contact with the top surface of the sandwich bar, the battery cell further including a first fillet weld joint interconnecting the top surface of the sandwich bar to the bottom surface of the battery terminal adjacent a first side of the sandwich bar, and a second fillet weld joint interconnecting the top surface of the sandwich bar to the bottom surface of the battery terminal adjacent a second side of the sandwich bar.

According to another aspect, the first fillet weld joint and second fillet weld joint are laser welds oriented at an angle of between approximately seven degrees and approximately ten degrees relative to the top surface of the sandwich bar and the bottom surface of the battery terminal.

According to another aspect, the battery cell includes a slot bar positioned between and electrically interconnecting the sandwich bar and the battery terminal.

According to another aspect, the slot bar includes a first longitudinal runner positioned adjacent to, in direct contact with and extending along a first side of the sandwich bar, a second longitudinal runner positioned adjacent to, in direct contact with and extending along a second side of the sandwich bar, a first bridge portion interconnecting and extending upward from first distal ends of the first and second longitudinal runners, extending laterally between the first distal ends of the first and second longitudinal runners, and having a first bottom surface that includes a first recess formed therein, and a second bridge portion interconnecting and extending upward from second distal ends of the first and second longitudinal runners, extending laterally between the second distal ends of the first and second longitudinal runners, and having a second bottom surface that includes a second recess formed therein, the first and second bridge portions and the first and second longitudinal runners defining a channel, the slot bar positioned onto the sandwich bar, with the sandwich bar positioned within the channel, wherein the welded joint of the sandwich bar is received within the first recess and the second recess and the slot bar is in direct contact with the top surface of the sandwich bar, the battery cell further including a first lap weld interconnecting the first longitudinal runner to the first side of the sandwich bar, and a second lap weld interconnecting the second longitudinal runner to the second side of the sandwich bar.

According to another aspect, the first bridge portion extends upward and is received within a first passage within the battery terminal, and the second bridge portion extends upward and is received within a second passage within the battery terminal.

According to another aspect, the first longitudinal runner includes a first channel formed within an outer surface thereof, wherein the first lap weld is positioned within the first channel formed within the first longitudinal runner, and the second longitudinal runner includes a second channel formed within an outer surface thereof, wherein the second lap weld is positioned within the second channel formed within the second longitudinal runner.

According to another aspect, the slot bar includes a longitudinal runner positioned adjacent to, in direct contact with and extending along a first side of the sandwich bar, a first bridge portion extending upward from a first distal end of the longitudinal runner, extending laterally over the sandwich bar, and having a first bottom surface that includes a first recess formed therein, and a second bridge portion extending upward from a second distal end of the longitudinal runner, extending laterally over the sandwich bar, and having a second bottom surface that includes a second recess formed therein, the slot bar positioned onto the sandwich bar, with the sandwich bar positioned adjacent to and in direct contract with the longitudinal runner, and wherein the welded joint of the sandwich bar is received within the first recess and the second recess and the slot bar is in direct contact with the top surface of the sandwich bar, the battery cell further including a lap weld interconnecting the longitudinal runner to the first side of the sandwich bar.

According to another aspect, the first bridge portion extends upward and is received within a first passage within the battery terminal, and the second bridge portion extends upward and is received within a second passage within the battery terminal.

According to another aspect, the longitudinal runner includes a channel formed within an outer surface thereof, wherein the lap weld is positioned within the channel formed within the longitudinal runner.

According to another aspect, the slot bar includes a structural reinforcement extending laterally outward from the longitudinal runner and dividing the channel into a first segment and a second segment, and the lap weld including a first weld segment positioned within the first segment of the channel and a second weld segment positioned within the second segment of the channel.

According to another aspect, the battery terminal includes a generally U-shaped terminal plate including a first end including a flange having a first laterally extending finger positioned adjacent to and in direct contact with a first side of the sandwich bar and a second laterally extending finger positioned adjacent to and in direct contact with a second side of the sandwich bar, a second end including a flange having first laterally extending finger positioned adjacent to and in direct contact with a first side of the sandwich bar and a second laterally extending finger positioned adjacent to and in direct contact with a second side of the sandwich bar, and a terminal surface extending laterally between the first and second ends and spaced above the sandwich bar, the battery cell further including a first lap weld interconnecting the first laterally extending finger of the first end of the generally U-shaped terminal plate to the first side of the sandwich bar, a second lap weld interconnecting the second laterally extending finger of the first end of the generally U-shaped terminal plate to the second side of the sandwich bar, a third lap weld interconnecting the first laterally extending finger of the second end of the generally U-shaped terminal plate to the first side of the sandwich bar, and a fourth lap weld interconnecting the second laterally extending finger of the second end of the generally U-shaped terminal plate to the second side of the sandwich bar.

According to several aspects of the present disclosure, a vehicle includes a battery cell including a sandwich bar securing and interconnecting a plurality of electrode tabs and including a welded joint that fuses the plurality of electrode tabs to the sandwich bar, the welded joint extending upward beyond a top surface of the sandwich bar, and a battery terminal electrically connected, via a weld, to the sandwich bar.

According to several aspects of the present disclosure, a method of interconnecting a plurality of electrode tabs of a battery cell to a battery terminal of the battery cell includes forming a welded joint that fuses a plurality of electrode tabs to a sandwich bar and secures the plurality of electrode tabs therein, wherein, the welded joint extends upward beyond a top surface of the sandwich bar, and forming a weld that electrically interconnects a battery terminal to the sandwich bar.

According to another aspect, the forming a weld that electrically interconnects the battery terminal to the sandwich bar further includes one of positioning the battery terminal onto the sandwich bar, wherein the welded joint is received within a recess formed within a bottom surface of the battery terminal and the bottom surface of the battery terminal is in direct contact with the top surface of the sandwich bar, laser welding a first fillet weld joint that interconnects the top surface of the sandwich bar to the bottom surface of the battery terminal adjacent a first side of the sandwich bar, wherein the first fillet weld joint is oriented at an angle of between approximately seven degrees and approximately ten degrees relative to the top surface of the sandwich bar and the bottom surface of the battery terminal, and laser welding a second fillet weld joint that interconnects the top surface of the sandwich bar to the bottom surface of the battery terminal adjacent a second side of the sandwich bar, wherein the second fillet weld joint is oriented at an angle of between approximately seven degrees and approximately ten degrees relative to the top surface of the sandwich bar and the bottom surface of the battery terminal, or positioning a battery terminal that comprises a generally U-shaped terminal plate onto the sandwich bar, wherein a first end of the generally U-shaped terminal plate includes a flange having a first laterally extending finger positioned adjacent to and in direct contact with a first side of the sandwich bar and a second laterally extending finger positioned adjacent to and in direct contact with a second side of the sandwich bar, and a second end of the generally U-shaped terminal plate includes a flange having a first laterally extending finger positioned adjacent to and in direct contact with a first side of the sandwich bar and a second laterally extending finger positioned adjacent to and in direct contact with a second side of the sandwich bar, and a terminal surface extending laterally between the first and second ends and spaced above the sandwich bar, laser welding a first lap weld that interconnects the first laterally extending finger of the first end of the generally U-shaped terminal plate to the first side of the sandwich bar, laser welding a second lap weld that interconnects the second laterally extending finger of the first end of the generally U-shaped terminal plate to the second side of the sandwich bar, laser welding a third lap weld that interconnects the first laterally extending finger of the second end of the generally U-shaped terminal plate to the first side of the sandwich bar, and laser welding a fourth lap weld that interconnects the second laterally extending finger of the second end of the generally U-shaped terminal plate to the second side of the sandwich bar.

According to another aspect, the forming a weld that electrically interconnects the battery terminal to the sandwich bar further includes one of positioning a two-sided slot bar between and electrically interconnecting the sandwich bar and the battery terminal, wherein the two-sided slot bar includes a first longitudinal runner positioned adjacent to, in direct contact with and extending along a first side of the sandwich bar and including a first channel formed within an outer surface thereof, a second longitudinal runner positioned adjacent to, in direct contact with and extending along a second side of the sandwich bar and including a second channel formed within an outer surface thereof, a first bridge portion interconnecting and extending upward from first distal ends of the first and second longitudinal runners and being received within a first passage within the battery terminal, extending laterally between the first distal ends of the first and second longitudinal runners, and having a first bottom surface that includes a first recess formed therein, and a second bridge portion interconnecting and extending upward from second distal ends of the first and second longitudinal runners and being received within a second passage within the battery terminal, extending laterally between the second distal ends of the first and second longitudinal runners, and having a second bottom surface that includes a second recess formed therein, the first and second bridge portions and the first and second longitudinal runners defining a channel, the two-sided slot bar positioned onto the sandwich bar, with the sandwich bar positioned within the channel, wherein the welded joint of the sandwich bar is received within the first recess and the second recess and the two-sided slot bar is in direct contact with the top surface of the sandwich bar, laser welding a first lap weld within the first channel formed within the first longitudinal runner and interconnecting the first longitudinal runner to the first side of the sandwich bar and laser welding a second lap weld within the second channel formed within the second longitudinal runner and interconnecting the second longitudinal runner to the second side of the sandwich bar, or, positioning a one-sided slot bar between and electrically interconnecting the sandwich bar and the battery terminal, wherein the one-sided slot bar includes a longitudinal runner positioned adjacent to, in direct contact with and extending along a first side of the sandwich bar and including a channel formed within an outer surface thereof, a first bridge portion extending upward from a first distal end of the longitudinal runner and being received within a first passage within the battery terminal, extending laterally over the sandwich bar, and having a first bottom surface that includes a first recess formed therein, a second bridge portion extending upward from a second distal end of the longitudinal runner and being received within a second passage within the battery terminal, extending laterally over the sandwich bar, and having a second bottom surface that includes a second recess formed therein, and a structural reinforcement extending laterally outward from the longitudinal runner and dividing the channel into a first segment and a second segment, the one-sided slot bar positioned onto the sandwich bar, with the sandwich bar positioned adjacent to and in direct contract with the longitudinal runner, and wherein the welded joint of the sandwich bar is received within the first recess and the second recess and the one-sided slot bar is in direct contact with the top surface of the sandwich bar, and laser welding a first lap weld segment within the first segment of the channel and a second lap weld segment within the second segment of the channel, and interconnecting the longitudinal runner to the first side of the sandwich bar.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle having a battery cell in accordance with an exemplary embodiment of the present disclosure;

FIG. 2 is a cross-sectional view of the battery cell shown in claim 1;

FIG. 3 is a cross-sectional view illustrating how a foil electrode stack is welded to attached the foil electrodes to one another and to a sandwich bar;

FIG. 4 is a perspective view of an exemplary embodiment of the present disclosure wherein a battery terminal is welded onto a sandwich bar;

FIG. 5 is a sectional view taken along line “FIGS. 5 – 5” in FIG. 4;

FIG. 6 is a perspective view of an exemplary embodiment of the present disclosure wherein a two-sided slot bar interconnects the battery terminal to the sandwich bar;

FIG. 7 is a perspective view of the embodiment shown in FIG. 6, that is rotated to provide a view of the sandwich bar and the two-sided slot bar with the cathode foil stack and anode foil stack removed;

FIG. 8A is a perspective top view of the battery terminal and two-sided slot bar shown in FIGS. 6 and 7;

FIG. 8B is a perspective bottom view of the battery terminal and two-sided slot bar shown in FIGS. 6 and 7;

FIG. 9 is a cross sectional view taken along lines “FIGS. 9 – 9” at two locations of FIG. 6;

FIG. 10 is a perspective view of an exemplary embodiment of the present disclosure wherein a one-sided slot bar interconnects the battery terminal to the sandwich bar;

FIG. 11 is a perspective bottom view of the battery terminal and one-sided slot bar shown in FIG. 10;

FIG. 12 is a cross-sectional view taken along lines “FIGS. 12 – 12” at two locations of FIG. 10;

FIG. 13 is a side view of an exemplary embodiment wherein a generally U-shaped terminal plate is welded onto the sandwich bar;

FIG. 14 is a perspective view of first and second ends of th generally U-shaped terminal plate shown in FIG. 13; and

FIG. 15 is a flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5 %, “about”, with reference to temperatures, comprises a variation of plus/minus five degrees, and “about”, with reference to distances, comprises plus/minus 10 %. In addition, disclosure of ranges includes disclosure of all values and further divided ranges within the entire range, including endpoints and sub-ranges given for the ranges.

In addition, disclosure of ranges includes disclosure of all values and further divided ranges within the entire range, including endpoints and sub-ranges given for the ranges.

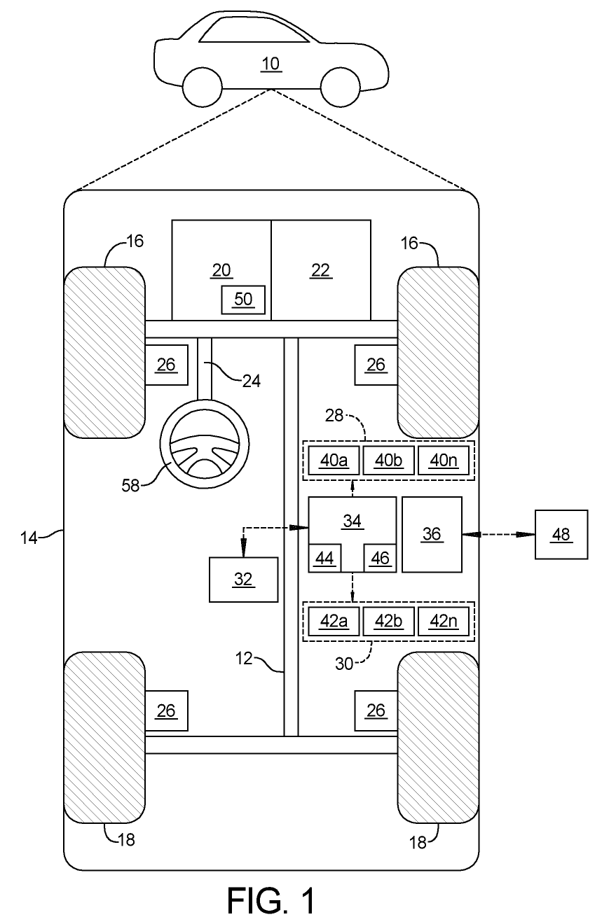

Example embodiments will now be described more fully with reference to the accompanying drawings. In accordance with an exemplary embodiment, FIG. 1 shows a vehicle 10 with a battery cell 50 in accordance with the present disclosure. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. An autonomous vehicle may be equipped with different levels (Level One, Level Two, etc.) of autonomous capability. A Level One autonomous vehicle, for example, provides minimal capability to control operation of the vehicle 10. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to a battery cell within a non-autonomous vehicles.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. The propulsion system 20 may, in various embodiments, include an internal combustion engine, an electric machine such as a traction motor, and/or a fuel cell propulsion system.

In an embodiment in which the vehicle 10 is an electric vehicle, there may be no transmission system 22, and the battery cell 50 may be one of a plurality of battery cells 50 connected to the propulsion system and adapted to provide power to electric motors within the vehicle 10. In a hybrid or full-electric vehicle, the engine assembly, fuel supply system, and exhaust system of an ICE-based vehicle are replaced with a single or multiple electrical motors, a battery pack, and battery cooling and charging hardware of the electrical system. Many hybrid electric and full electric vehicles employ a rechargeable battery pack to store and supply the requisite power for operating motors of an electric propulsion system 20. In order to generate tractive power with sufficient vehicle range and speed, a battery pack is significantly larger, more powerful, and higher in capacity (Amp-hr) than a standard 12-volt starting, lighting, and ignition (SLI) battery. Compared to the single cell of an SLI battery, contemporary battery packs for electric vehicles group stacks of battery cells into individual battery modules, which are then mounted onto the vehicle chassis 12, e.g., by a battery pack housing or support tray. Modules made up of stacked electrochemical battery cells may be connected in series or parallel through use of an electrical interconnect board (ICB), or modules may be connected directly to one another. Individual battery modules are electrically connected together via a busbar assembly adapted to connect one battery module to another battery module, or to connect a battery module to an ICB.

The transmission system 22 is configured to transmit power from the propulsion system 20 to the vehicle’s front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle’s front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image or map. The plurality of sensing devices 40a-40n is used to determine information about an environment surrounding the vehicle 10. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor.

The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the at least one processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

A battery within the vehicle 10 may be discharged upon application of a load and recharged upon the application of an external power source. A battery includes one or more battery cells 50, that are assembled together. During discharge, when a load is applied to the battery, Li+ ions move from an anode to a cathode through a separator by way of an electrolyte. Equivalent electrons e- move through the connected load circuitry from the cathode to the anode, providing energy to the load. While charging, upon application of an external voltage, Li+ ions move from the cathode to the anode by way of the electrolyte through the separator and may be intercalated into the anode.

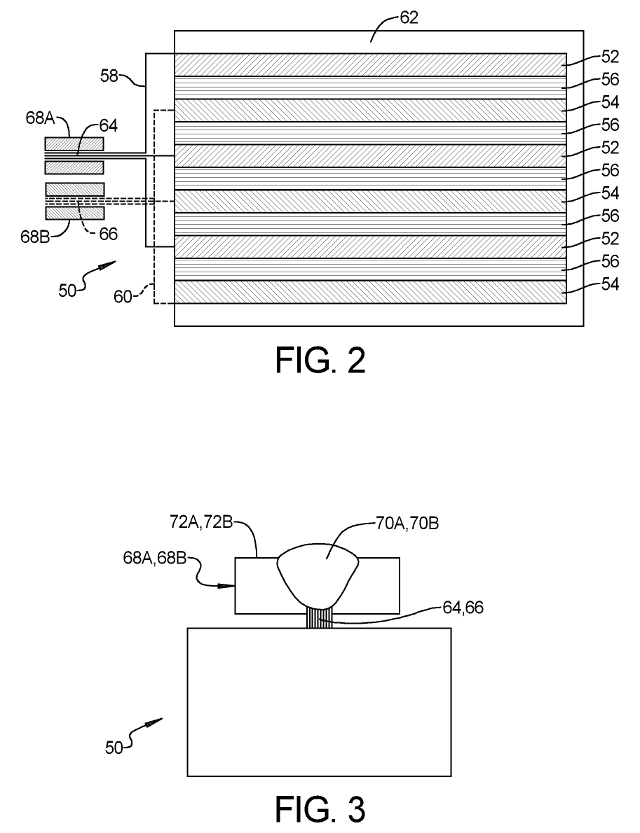

Referring to FIG. 2, wherein a cross section of an exemplary embodiment of a battery cell 50 is shown, the battery cell 50 includes at least one cathode electrode 52 and at least one anode electrode 54. The battery cell 50 includes a plurality of cathode electrodes 52 and anode electrodes 54 alternately arranged with separators 56 positioned therebetween. The plurality of cathode electrodes 52, anode electrodes 54 and separators 56 may be configured in a stacked or jellyroll configuration as is known in the art of prismatic battery cells. Each of the plurality of cathode electrodes 52 includes a foil electrode tab 58 extending therefrom, and each of the plurality of anode electrodes 54 includes a foil electrode tab 60 extending therefrom. The foil electrode tabs 58, 60 may be integrally formed with the respective cathode electrode 52 or anode electrode 54 by trimming or punching the cathode electrode 52 or anode electrode 54, including the foil electrode tab 58, 60 from larger foil sheet. Alternatively, the foil electrode tabs 58, 60 may be welded onto the cathode/anode electrodes 52, 54 after punching or trimming.

The battery cell 50 includes a casing 62 that is relatively rigid and exhibits a generally cuboid configuration, hermetically sealing the cathode electrodes 52, anode electrodes 54, separators 56 and electrolyte therein. The foil electrode tabs 58 of the cathode electrodes 52 are welded together to form a cathode foil stack 64 and the foil electrode tabs 60 of the anode electrodes 54 are welded together to form an anode foil stack 66. While one cathode foil stack 64 is shown and one anode foil stack 66 is shown, multiple cathode foil stacks 64 and multiple anode foil stacks 66 may be present. While it is illustrated that the foil tabs 58, 60 protrude from the battery cell 50 in the same direction, in additional or alternative embodiments, the foil stacks 58, 60 may protrude from the battery cell 50 in different directions, such as from opposing directions.

The cathode electrodes 52 include an active material that provides a source of lithium ions (Li+) and can undergo reversible insertion or intercalation of lithium ions, determining e.g., the capacity and average voltage of a battery. In embodiments, the active material includes at least one of lithium iron phosphate (LFP), lithium cobalt oxide (LiCoO2), lithium manganese oxide (LiMn2O4), lithium manganese iron phosphate (LMFP), and lithium nickel manganese cobalt oxide (LiNiMnCoO2).

The anode electrodes 54 include materials that can undergo reversible insertion or intercalation of lithium ions at a lower electrochemical potential than the material of the cathode electrodes 52, such that an electrochemical potential difference exists between the cathode electrodes 52 and the anode electrodes 54. The anode material may include one or more of lithium metal; alloys of lithium such as lithium silicon alloy, lithium aluminum alloy, lithium indium alloy, lithium titanate, and lithium tin alloy; carbon based materials such as graphite, activated carbon, carbon black and graphene; silicon; silicon based alloys; silicon oxide; silicon based composite materials; tin oxide; aluminum; indium; zinc; germanium; and titanium oxide; as well as any combination of the above.

The separators 56 are a porous material, electrically insulative material that prevents the cathode electrodes 52 and anode electrodes 54 from contacting and potentially shortening out the circuit. The separators 56 are sandwiched, or at least partially enclosed, between the cathode electrodes 52 and anode electrodes 54, allowing the passage of the lithium ions and electrolyte through the pores of the separators 56. The separators 56 may include one or more of a composite, a polymeric material, and a non-woven material.

The electrolyte provides a medium between the cathode electrodes 52 and the anode electrodes 54 through which lithium ions travel. The medium may be a liquid, gel, or solid, and capable of conducting the lithium ions between the cathode electrodes 52 and the anode electrodes 54. The electrolyte permeates the pores of the porous separators 56 and wets, or otherwise contacts, the surfaces of the cathode electrodes 52 and anode electrodes 54 as well as the separators 56. In embodiments, the electrolyte includes one or more lithium salts dissolved in non-aqueous organic solvent.

The battery cell 50 includes a first sandwich bar 68A securing and interconnecting the plurality of foil electrode tabs 58 of the cathode foil stack 64 and includes a first welded joint 70A that fuses the plurality of foil electrode tabs 58 to one another and to the first sandwich bar 68A and extends upward beyond a top surface 72A of the first sandwich bar 68A. The battery cell 50 further includes a second sandwich bar 68B securing and interconnecting the plurality of foil electrode tabs 60 of the anode foil stack 66 and including a second welded joint 70B that fuses the plurality of foil electrode tabs 60 to one another and to the second sandwich bar 68B and extends upward beyond a top surface 72B of the second sandwich bar 68B. A battery terminal 74 is electrically connected, via a weld, to each of the sandwich bars 68A, 68B. It should be understood that the novel aspects of the present disclosure related to the attachment of a battery terminal 74 to each of the sandwich bars 68A, 68B are identical for each of the first sandwich bar 68A/cathode foil stack 64 and the second sandwich bar 68B/anode foil stack 66.

Referring to FIG. 3, which illustrates a cross section of either one of the first sandwich bar 68A or second sandwich bar 68B. The foil electrode tabs 58, 60 are clamped together to form the foil stack 64, 66 (cathode foil stack 64, anode foil stack 66). The welded joints 70A, 70B (first welded joint 70A, second welded joint 70B) are formed by laser welding, wherein a laser light beam is emitted from a laser onto an incident surface of the foil stack 64, 66. The first and second welded joints 70A, 70B comprise a weld nugget formed by the core of the laser beam along with a solid-state diffusion bonding zone formed around a portion the weld nugget by the ring of the light beam. The weld nugget is a pool of molten metal that is generally formed by the core of the light emitted by the laser during laser welding that hardens upon cooling.

Further details of the formation of the welded joints 70A, 70B of the first and second sandwich bars 68A, 68B can be found in United States Patent Application No. 18/982,741 entitled “HYBRID FOIL WELD JOINT AND WELDING METHODS”, filed on Dec. 16, 2024, the entire contents of which is hereby incorporated by reference.

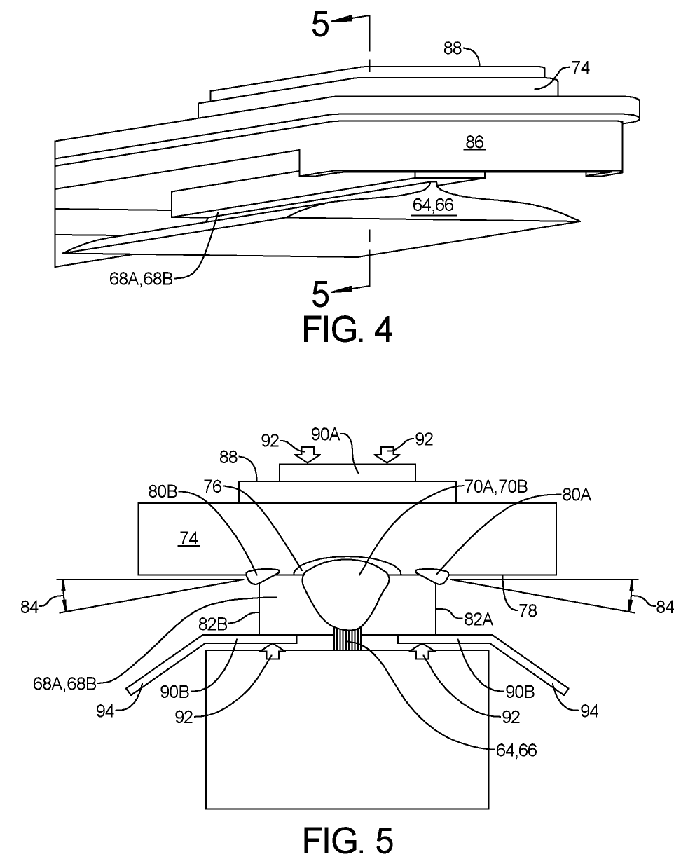

Referring to FIGS. 4 and 5, in an exemplary embodiment, the battery terminal 74 includes a recess 76 formed within a bottom surface 78 of the battery terminal. The battery terminal 74 is positioned onto the sandwich bar 68A, 68B, wherein the welded joint 70A, 70B is received within the recess 76 and the bottom surface 78 of the battery terminal 74 is in direct contact with the top surface 72A, 72B of the sandwich bar 68A, 68B. The battery cell further includes a first fillet weld joint 80A interconnecting the top surface 72A, 72B of the sandwich bar 68A, 68B to the bottom surface 78 of the battery terminal 74 adjacent a first side 82A of the sandwich bar 68A, 68B, and a second fillet weld joint 80B interconnecting the top surface 72A, 72B of the sandwich bar 68A, 68B to the bottom surface 78 of the battery terminal 74 adjacent a second side 82B of the sandwich bar 68A, 68B.

In an exemplary embodiment, the first fillet weld joint 80A and second fillet weld joint 80B are laser welds oriented at an angle 84 of between approximately seven degrees and approximately ten degrees relative to the top surface 72A, 72B of the sandwich bar 68A, 68B and the bottom surface 78 of the battery terminal 74.

As shown in FIG. 4, the battery terminal is housed within non-conductive materials forming a cap assembly 86, wherein when the battery terminal 74 is welded, via the first and second fillet weld joints 80A, 80B, to the sandwich bar 68A, 68B, the cap assembly 86 and the battery casing 62 hermetically seals all contents of the battery cell within the battery casing 62, allowing only a top surface 88 of the battery terminal 74 to be exposed for connection to an electrical system of the vehicle 10. The cap assembly is generally formed by over-molding or potting the non-conductive materials onto the battery terminal 74 after the battery terminal 74 is secured to the sandwich bar 68A, 68B. The cross-sectional view of FIG. 5 is shown without the cap assembly 86.

As shown in FIG. 5, clamping members 90A and 90B secure apply pressure, as indicated by arrows 92 to hold the battery terminal 74 in contact with the top surface 72A, 72B of the sandwich bar 68A, 68B. In an exemplary embodiment, the clamping members 90B include a shield portion 94 adapted to protect the battery cell 50 from heat and/or spatter generated during laser welding of the first and second fillet weld joints 80A, 80B.

In another exemplary embodiment, the battery cell 50 includes a slot bar 96 positioned between and electrically interconnecting the sandwich bar 68A, 68B and the battery terminal 74.

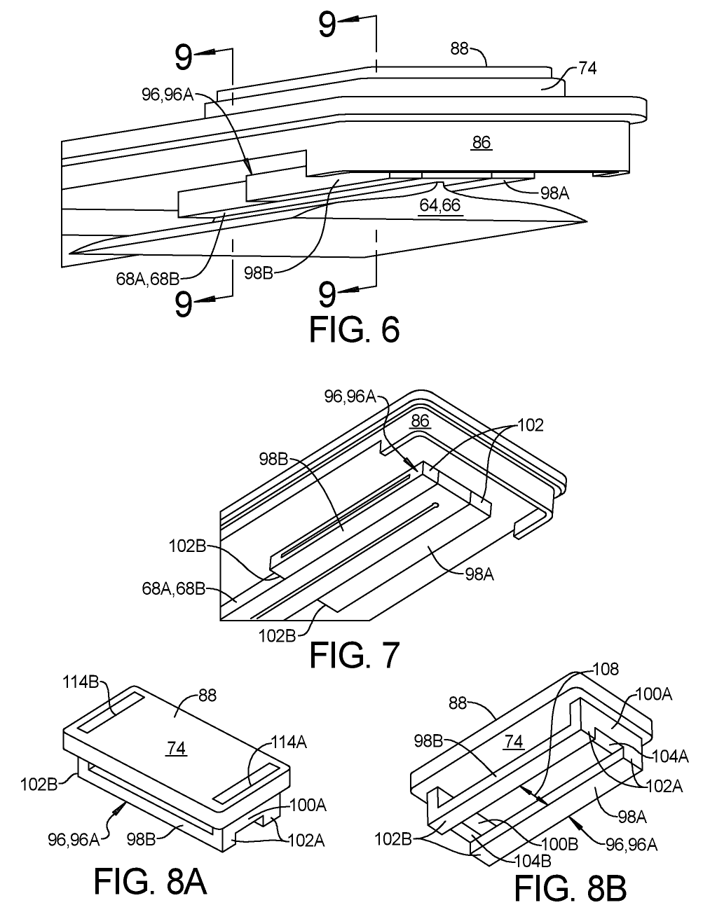

Referring to FIGS. 6, 7, 8A, 8B and 9, in another exemplary embodiment, the slot bar 96 is a two-sided slot bar 96A that includes a first longitudinal runner 98A positioned adjacent to, in direct contact with and extending along the first side 82A of the sandwich bar 68A, 68B and a second longitudinal runner 98B positioned adjacent to, in direct contact with and extending along the second side 82B of the sandwich bar 68A, 68B. A first bridge portion 100A interconnects and extends upward from first distal ends 102A of the first and second longitudinal runners 98A, 98B, extending laterally between the first distal ends 102A of the first and second longitudinal runners 98A, 98B, and having a first bottom surface 104A that includes a first recess 106A formed therein, and a second bridge portion 100B interconnects and extends upward from second distal ends 102B of the first and second longitudinal runners 98A, 98B, extending laterally between the second distal ends 102B of the first and second longitudinal runners 98A, 98B, and having a second bottom surface 104B that includes a second recess 106B formed therein.

The first and second bridge portions 100A, 100B and the first and second longitudinal runners 98A, 98B defining a channel 108, the slot bar 96A positioned onto the sandwich bar 68A, 68B, with the sandwich bar 68A, 68B positioned within the channel 108, wherein the welded joint 70A, 70B of the sandwich bar 68A, 68B is received within the first recess 106A and the second recess 106B and the slot bar 96A is in direct contact with the top surface 72A, 72B of the sandwich bar 68A, 68B.

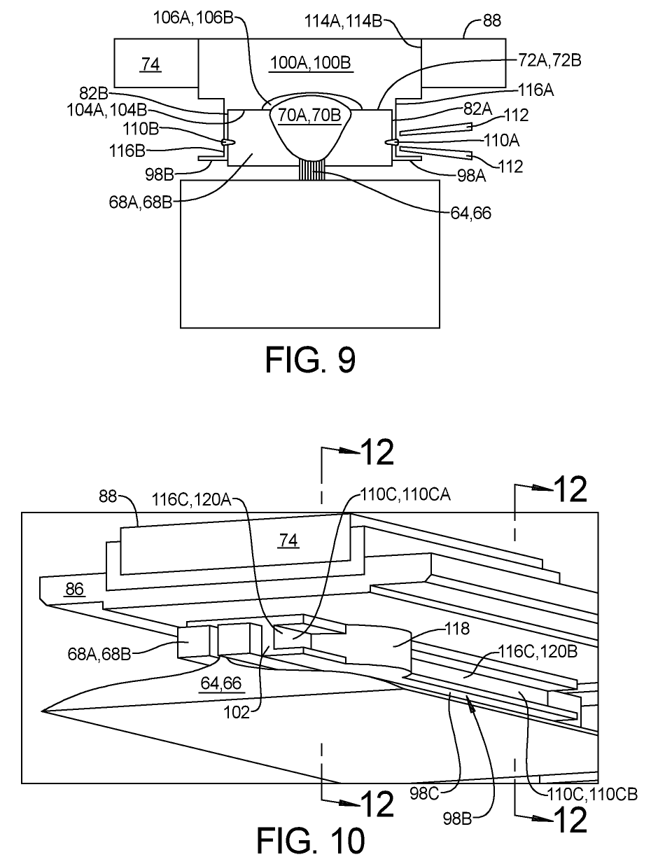

Referring specifically to FIG. 9, wherein FIG. 9 is a cross sectional view through the battery terminal 74, the two sided slot bar 96A and the sandwich bar 68A, 68B taken through both the first bridge portion 100A of the two-sided slot bar 96A and the second bridge portion 100B of the two-sided slot bar 96A, a first lap weld 110A interconnects the first longitudinal runner 98A to the first side 82A of the sandwich bar 68A, 68B, and a second lap weld 110B interconnects the second longitudinal runner 98B to the second side 82B of the sandwich bar 68A, 68B. In an exemplary embodiment, during laser welding of the first and second lap welds 110A, 110B, shield members 112 are positioned in proximity to the weld locations to protect the battery cell 50 from heat and/or spatter during laser welding of the first and second lap welds 110A, 110B. Further , the shield members 112 may also function to provide clamping force to push the first and second longitudinal runners 98A, 98B firmly against the first and second sides 82A, 82B of the sandwich bar 68. Any gaps therebetween will negatively impact the quality of the weld between the first and second longitudinal runners 98A, 98B firmly against the first and second sides 82A, 82B of the sandwich bar 68.

Referring specifically to FIGS. 8A and 9, in an exemplary embodiment, the first bridge portion 100A extends upward and is received within a first passage 114A within the battery terminal 74, and the second bridge portion 100B extends upward and is received within a second passage 114B within the battery terminal 74. Engagement of the first and second bridge portions 100A, 100B attaches the two-sided slot bar to the battery terminal 74 and creates an electrically conductive connection therebetween. In various embodiment, the first and second bridge portions 100A, 100B may be engaged with the first and second passages 114A, 114B via an interference or press-fit, or the first and second bridge portions 100A, 100B may be welded within the first and second passages 114A, 114B.

In another exemplary embodiment, referring again to FIG. 9, the first longitudinal runner 98A includes a first channel 116A formed within an outer surface thereof, wherein the first lap weld 110A is positioned within the first channel 116A formed within the first longitudinal runner 98A, and the second longitudinal runner 98B includes a second channel 116B formed within an outer surface thereof, wherein the second lap weld 110B is positioned within the second channel 116B formed within the second longitudinal runner 98B. The first and second channels 116A, 116B reduce a thickness of the first and second longitudinal runners 98A, 98B, making formation of the first and second lap welds 110A, 110B more efficient and resulting in stronger first and second lap welds 110A, 110B.

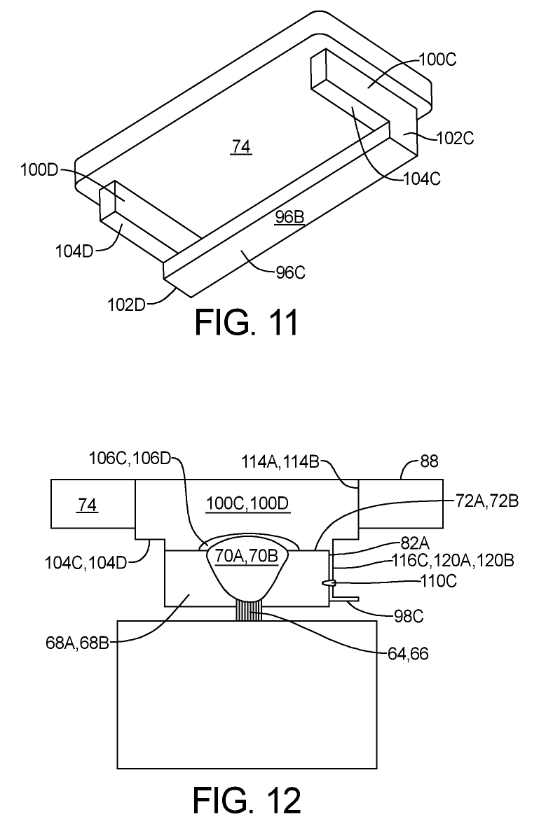

Referring to FIGS. 10, 11 and 12, in another exemplary embodiment, the slot bar 96 is a one-sided slot bar 96B that includes a longitudinal runner 98C positioned adjacent to, in direct contact with and extending along the first side 82A of the sandwich bar 68A, 68B. A first bridge portion 100C extends upward from a first distal end 102C of the longitudinal runner 98C, extends laterally over the sandwich bar 68A,68B, and has a first bottom surface 104C that includes a first recess 106C formed therein, and a second bridge portion 100D extending upward from a second distal end 102D of the longitudinal runner 98C, extending laterally over the sandwich bar 68A, 68B, and having a second bottom surface 104D that includes a second recess 106D formed therein.

The one-sided slot bar 96B is positioned onto the sandwich bar 68A, 68B, with the sandwich bar 68A, 68B positioned adjacent to and in direct contract with the longitudinal runner 98C, and wherein the welded joint 70A, 70B of the sandwich bar 68A, 68B is received within the first recess 106C and the second recess 106D and the one-sided slot bar 96B is in direct contact with the top surface 72A, 72B of the sandwich bar 68A, 68B.

Referring specifically to FIG. 12, wherein FIG. 12 is a cross sectional view through the battery terminal 74, the one-sided slot bar 96B and the sandwich bar 68A, 68B taken through both the first bridge portion 100C of the one-sided slot bar 96B and the second bridge portion 100D of the one-sided slot bar 96B, a lap weld 110C interconnects the longitudinal runner 98C to the first side 82A of the sandwich bar 68A, 68B.

Referring to FIGS. 8A and 12, similarly to the two-sided slot bar 96A, the first bridge portion 100C of the one-sided slot bar 96B extends upward and is received within a first passage 114A within the battery terminal 74, and the second bridge portion 100D of the one-sided slot bar 96B extends upward and is received within a second passage 114B within the battery terminal 74. Engagement of the first and second bridge portions 100C, 100D attaches the one-sided slot bar 96B to the battery terminal 74 and creates an electrically conductive connection therebetween. In various embodiments, the first and second bridge portions 100C, 100D may be engaged with the first and second passages 114A, 114B via an interference or press-fit, or the first and second bridge portions 100C, 100D may be welded within the first and second passages 114A, 114B.

In another exemplary embodiment, referring again to FIG. 12, the longitudinal runner 98C of the one-sided slot bar 96B includes a channel 116C formed within an outer surface thereof, wherein the lap weld 110C is positioned within the channel 116C formed within the longitudinal runner 98C. The channel 116C reduces a thickness of the longitudinal runner 98C making formation of the lap weld 110C more efficient and resulting in a stronger lap weld 110C.

Referring again to FIG. 10, in an exemplary embodiment, the one-side slot bar 96B (as shown) or the two-sided slot bar 96A includes a structural reinforcement 118 extending laterally outward from the longitudinal runner 98C and dividing the channel 116C into a first segment 120A and a second segment 120B. The lap weld 110C includes a first weld segment 110CA positioned within the first segment 120A of the channel 116C and a second weld segment 110CB positioned within the second segment 120B of the channel 116C. This structural reinforcement 118 provides a thicker region of the slot bar 96A, 96B in proximity to the attachment of the slot bar 96A, 96B to the sandwich bar 68A, 68B and the attachment of the slot bar 96A, 96B to the battery terminal 74, providing increased strength of the connection between the battery terminal 74 and the sandwich bar 68A, 68B.

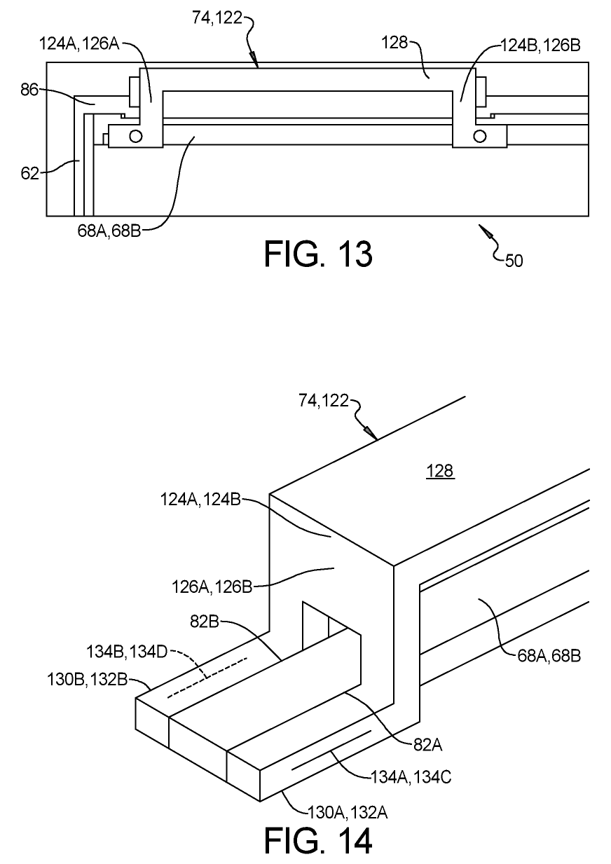

Referring to FIGS. 13 and 14, in another exemplary embodiment the battery terminal 74 includes a generally U-shaped terminal plate 122 including a first end 124A including a flange 126A and a second end 124B including a flange 126B, and a terminal surface 128 extending laterally between the first and second ends 124A, 124B and spaced above the sandwich bar 68A, 68B. Referring specific2Aally to FIG. 14, the first end 124A and flange 126A is identical to the second end 124B and flange 126B, thus, FIG. 14 is an image representing both and numbered with corresponding element numbers. The flange 126A of the first end 124A includes a first laterally extending finger 130A positioned adjacent to and in direct contact with the first side 82A of the sandwich bar 68A, 68B and a second laterally extending finger 130B positioned adjacent to and in direct contact with the second side 82B of the sandwich bar 68A, 68B. The flange 126B of the second end 124B includes a first laterally extending finger 132A positioned adjacent to and in direct contact with the first side 82A of the sandwich bar 68A, 68B and a second laterally extending finger 132B positioned adjacent to and in direct contact with the second side 82B of the sandwich bar 68A, 68B.

A first lap weld 134A interconnects the first laterally extending finger 130A of the first end 124A of the generally U-shaped terminal plate 122 to the first side 82A of the sandwich bar 68A, 68B, a second lap weld 134B interconnects the second laterally extending finger 130B of the first end 124A of the generally U-shaped terminal plate 122 to the second side 82B of the sandwich bar 68A, 68B, a third lap weld 134C interconnects the first laterally extending finger 132A of the second end 124B of the generally U-shaped terminal plate 122 to the first side 82A of the sandwich bar 68A, 68B, and a fourth lap weld 134D interconnects the second laterally extending finger 132B of the second end 124B of the generally U-shaped terminal plate 122 to the second side 82B of the sandwich bar 68A, 68B.

After the battery terminal 74/terminal plate 122 is secured to the sandwich bar 68A, 68B, the cap assembly 86 is generally formed by over-molding or potting the non-conductive materials onto the battery terminal 74/terminal plate 122, wherein the cap assembly 86 and the battery casing 62 hermetically seals all contents of the battery cell 50 within the battery casing 62, allowing only the terminal surface 128 of the U-shaped terminal plate 122 to be exposed for connection to an electrical system of the vehicle 10.

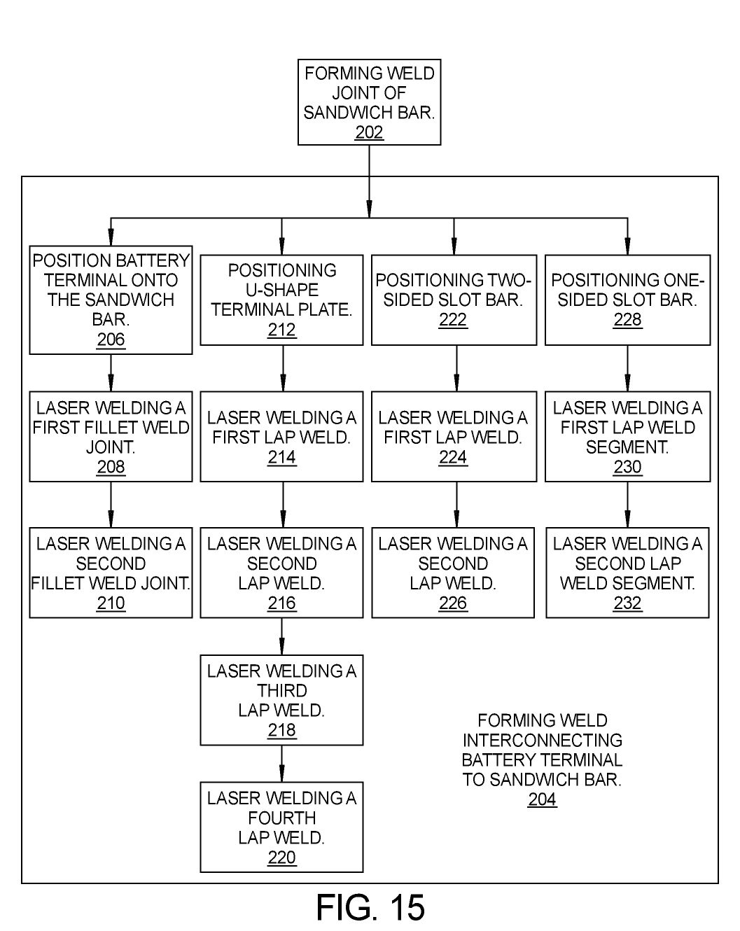

Referring to FIG. 15, a method 200 of interconnecting a plurality of electrode tabs 58, 60 of a battery cell 50 to a battery terminal 74 of the battery cell 50 includes, beginning at block 202, forming a welded joint 70A, 70B that fuses a plurality of electrode tabs 58, 60 to a sandwich bar 68A, 68B and secures the plurality of electrode tabs 58, 60 therein, wherein, the welded joint 70A, 70B extends upward beyond a top surface 72A, 72B of the sandwich bar 68A, 68B, and, moving to block 204, forming a weld that electrically interconnects a battery terminal 74 to the sandwich bar 68A, 68B.

In an exemplary embodiment, the forming a weld that electrically interconnects the battery terminal 74 to the sandwich bar 68A, 68B at block 204, further includes one of, moving from block 202 to block 206, positioning the battery terminal 74 onto the sandwich bar 68A, 68B, wherein the welded joint 70A, 70B is received within a recess 76 formed within a bottom surface 78 of the battery terminal 74 and the bottom surface 78 of the battery terminal 74 is in direct contact with the top surface 72A, 72B of the sandwich bar 68A, 68B, moving to block 208, laser welding a first fillet weld joint 80A that interconnects the top surface 72A, 72B of the sandwich bar 68A, 68B to the bottom surface 78 of the battery terminal 74 adjacent a first side 82A of the sandwich bar 68A, 68B, wherein the first fillet weld joint 80A is oriented at an angle of between approximately seven degrees and approximately ten degrees relative to the top surface 72A, 72B of the sandwich bar 68A, 68B and the bottom surface 78 of the battery terminal 74, and, moving to block 210, laser welding a second fillet weld joint 80B that interconnects the top surface 72A,72B of the sandwich bar 68A, 68B to the bottom surface 78 of the battery terminal 74 adjacent a second side 82B of the sandwich bar 68A, 68B, wherein the second fillet weld joint 80B is oriented at an angle of between approximately seven degrees and approximately ten degrees relative to the top surface 72A, 72B of the sandwich bar 68A, 68B and the bottom surface 78 of the battery terminal 74, or, moving from block 202 to block 212, positioning a battery terminal 74 that comprises a generally U-shaped terminal plate 122 onto the sandwich bar 68A, 68B, wherein a first end 124A of the generally U-shaped terminal plate 122 includes a flange 126A having a first laterally extending finger 130A positioned adjacent to and in direct contact with a first side 82A of the sandwich bar 68A, 68B and a second laterally extending finger 130B positioned adjacent to and in direct contact with a second side 82B of the sandwich bar 68A, 68B, and a second end 124B of the generally U-shaped terminal plate 122 includes a flange 126B having a first laterally extending finger 132A positioned adjacent to and in direct contact with the first side 82A of the sandwich bar 68A, 68B and a second laterally extending finger 132B positioned adjacent to and in direct contact with the second side 82B of the sandwich bar 68A, 68B, and a terminal surface 128 extending laterally between the first and second ends 124A, 124B and spaced above the sandwich bar 68A, 68B, moving to block 214, laser welding a first lap weld 134A that interconnects the first laterally extending finger 130A of the first end 124A of the generally U-shaped terminal plate 122 to the first side 82A of the sandwich bar 68A, 68B, moving to block 216, laser welding a second lap weld 134B that interconnects the second laterally extending finger 130B of the first end 124A of the generally U-shaped terminal plate 122 to the second side 82B of the sandwich bar 68A, 68B, moving to block 218, laser welding a third lap weld 134C that interconnects the first laterally extending finger 132A of the second end 124B of the generally U-shaped terminal plate 122 to the first side 82A of the sandwich bar 68A, 68B, and, moving to block 220, laser welding a fourth lap weld 134D that interconnects the second laterally extending finger 132B of the second end 124B of the generally U-shaped terminal plate 122 to the second side 82B of the sandwich bar 68A, 68B.

In another exemplary embodiment, the forming a weld that electrically interconnects the battery terminal 74 to the sandwich bar 68A, 68B at block 202 further includes one of, moving from block 202 to block 222, positioning a two-sided slot bar 96A between and electrically interconnecting the sandwich bar 68A, 68B and the battery terminal 74, wherein the two-sided slot bar 96A includes a first longitudinal runner 98A positioned adjacent to, in direct contact with and extending along a first side 82A of the sandwich bar 68A, 68B and including a first channel 116A formed within an outer surface thereof, a second longitudinal runner 98B positioned adjacent to, in direct contact with and extending along a second side 82B of the sandwich bar 68A, 68B and including a second channel 116B formed within an outer surface thereof, a first bridge portion 100A interconnecting and extending upward from first distal ends 102A of the first and second longitudinal runners 98A, 98B and being received within a first passage 114A within the battery terminal 74, extending laterally between the first distal ends 102A of the first and second longitudinal runners 98A, 98B, and having a first bottom surface 104A that includes a first recess 106A formed therein, and a second bridge portion 100B interconnecting and extending upward from second distal ends 102B of the first and second longitudinal runners 98A, 98B and being received within a second passage 114B within the battery terminal 74, extending laterally between the second distal ends 102B of the first and second longitudinal runners 98A, 98B, and having a second bottom surface 104B that includes a second recess 106B formed therein, the first and second bridge portions 100A, 100B and the first and second longitudinal runners 98A, 98B defining a channel 108, the two-sided slot bar 96A positioned onto the sandwich bar 68A, 68B, with the sandwich bar 68A, 68B positioned within the channel 108, wherein the welded joint 70A, 70B of the sandwich bar 68A, 68B is received within the first recess 106A and the second recess 106B and the two-sided slot bar 96A is in direct contact with the top surface 72A, 72B of the sandwich bar 68A, 68B, moving to block 224, laser welding a first lap weld 110A within the first channel 116A formed within the first longitudinal runner 98A and interconnecting the first longitudinal runner 98A to the first side 82A of the sandwich bar 68A, 68B, and, moving to block 226, laser welding a second lap weld 110B within the second channel 116B formed within the second longitudinal runner 98B and interconnecting the second longitudinal runner 98B to the second side 82B of the sandwich bar 68A, 68B, or, moving from block 202 to block 228, positioning a one-sided slot bar 96B between and electrically interconnecting the sandwich bar 68A, 68B and the battery terminal 74, wherein the one-sided slot bar 96B includes a longitudinal runner 98C positioned adjacent to, in direct contact with and extending along the first side 82A of the sandwich bar 68A, 68B and including a channel 116C formed within an outer surface thereof, a first bridge portion 100C extending upward from a first distal end 102C of the longitudinal runner 98C and being received within a first passage 114A within the battery terminal 74, extending laterally over the sandwich bar 68A, 68B, and having a first bottom surface 104C that includes a first recess 106C formed therein, a second bridge portion 100D extending upward from a second distal end 102D of the longitudinal runner 98C and being received within a second passage 114B within the battery terminal 74, extending laterally over the sandwich bar 68A, 68B, and having a second bottom surface 104D that includes a second recess 106D formed therein, and a structural reinforcement 118 extending laterally outward from the longitudinal runner 98C and dividing the channel 116C into a first segment 120A and a second segment 120B, the one-sided slot bar 96B positioned onto the sandwich bar 68A, 68B, with the sandwich bar 68A, 68B positioned adjacent to and in direct contact with the longitudinal runner 98C, and wherein the welded joint 70A, 70B of the sandwich bar 68A, 68B is received within the first recess 106C and the second recess 106D and the one-sided slot bar 96B is in direct contact with the top surface 72A, 72B of the sandwich bar 68A, 68B, moving to block 230, laser welding a first lap weld segment 110CA within the first segment 120A of the channel 116C, and, moving to block 232, laser welding a second lap weld segment 110CB within the second segment 120B of the channel 116C, and interconnecting the longitudinal runner 98C to the first side 82A of the sandwich bar 68A, 68B.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A battery cell, comprising:
a sandwich bar securing and interconnecting a plurality of electrode tabs and including a welded joint that fuses the plurality of electrode tabs to the sandwich bar, the welded joint extending upward beyond a top surface of the sandwich bar; and
a battery terminal electrically connected, via a weld, to the sandwich bar.

2. The battery cell of claim 1, wherein:
the battery terminal includes a recess formed within a bottom surface thereof; and
the battery terminal is positioned onto the sandwich bar, wherein the welded joint is received within the recess and the bottom surface of the battery terminal is in direct contact with the top surface of the sandwich bar;
the battery cell further including:
a first fillet weld joint interconnecting the top surface of the sandwich bar to the bottom surface of the battery terminal adjacent a first side of the sandwich bar; and
a second fillet weld joint interconnecting the top surface of the sandwich bar to the bottom surface of the battery terminal adjacent a second side of the sandwich bar.

3. The battery cell of claim 2, wherein the first fillet weld joint and second fillet weld joint are laser welds oriented at an angle of between approximately seven degrees and approximately ten degrees relative to the top surface of the sandwich bar and the bottom surface of the battery terminal.

4. The battery cell of claim 1 including a slot bar positioned between and electrically interconnecting the sandwich bar and the battery terminal.

5. The battery cell of claim 4, wherein:
the slot bar includes:
a first longitudinal runner positioned adjacent to, in direct contact with and extending along a first side of the sandwich bar;
a second longitudinal runner positioned adjacent to, in direct contact with and extending along a second side of the sandwich bar;
a first bridge portion interconnecting and extending upward from first distal ends of the first and second longitudinal runners, extending laterally between the first distal ends of the first and second longitudinal runners, and having a first bottom surface that includes a first recess formed therein; and
a second bridge portion interconnecting and extending upward from second distal ends of the first and second longitudinal runners, extending laterally between the second distal ends of the first and second longitudinal runners, and having a second bottom surface that includes a second recess formed therein;
the first and second bridge portions and the first and second longitudinal runners defining a channel, the slot bar positioned onto the sandwich bar, with the sandwich bar positioned within the channel, wherein the welded joint of the sandwich bar is received within the first recess and the second recess and the slot bar is in direct contact with the top surface of the sandwich bar; and
the battery cell further including:
a first lap weld interconnecting the first longitudinal runner to the first side of the sandwich bar; and
a second lap weld interconnecting the second longitudinal runner to the second side of the sandwich bar.

6. The battery cell of claim 5, wherein:
the first bridge portion extends upward and is received within a first passage within the battery terminal; and
the second bridge portion extends upward and is received within a second passage within the battery terminal.

7. The battery cell of claim 5, wherein:
the first longitudinal runner includes a first channel formed within an outer surface thereof, wherein the first lap weld is positioned within the first channel formed within the first longitudinal runner; and
the second longitudinal runner includes a second channel formed within an outer surface thereof, wherein the second lap weld is positioned within the second channel formed within the second longitudinal runner.

8. The battery cell of claim 4, wherein:
the slot bar includes:
a longitudinal runner positioned adjacent to, in direct contact with and extending along a first side of the sandwich bar;
a first bridge portion extending upward from a first distal end of the longitudinal runner, extending laterally over the sandwich bar, and having a first bottom surface that includes a first recess formed therein; and
a second bridge portion extending upward from a second distal end of the longitudinal runner, extending laterally over the sandwich bar, and having a second bottom surface that includes a second recess formed therein;
the slot bar positioned onto the sandwich bar, with the sandwich bar positioned adjacent to and in direct contract with the longitudinal runner, and wherein the welded joint of the sandwich bar is received within the first recess and the second recess and the slot bar is in direct contact with the top surface of the sandwich bar; and
the battery cell further including:
a lap weld interconnecting the longitudinal runner to the first side of the sandwich bar.

9. The battery cell of claim 8, wherein:
the first bridge portion extends upward and is received within a first passage within the battery terminal; and
the second bridge portion extends upward and is received within a second passage within the battery terminal.

10. The battery cell of claim 8, wherein:
the longitudinal runner includes a channel formed within an outer surface thereof, wherein the lap weld is positioned within the channel formed within the longitudinal runner.

11. The battery cell of claim 10, wherein the slot bar includes a structural reinforcement extending laterally outward from the longitudinal runner and dividing the channel into a first segment and a second segment; and
the lap weld including a first weld segment positioned within the first segment of the channel and a second weld segment positioned within the second segment of the channel.

12. The battery cell of claim 1, wherein the battery terminal includes:
a generally U-shaped terminal plate including:
a first end including a flange having a first laterally extending finger positioned adjacent to and in direct contact with a first side of the sandwich bar and a second laterally extending finger positioned adjacent to and in direct contact with a second side of the sandwich bar;
a second end including a flange having first laterally extending finger positioned adjacent to and in direct contact with a first side of the sandwich bar and a second laterally extending finger positioned adjacent to and in direct contact with a second side of the sandwich bar; and
a terminal surface extending laterally between the first and second ends and spaced above the sandwich bar; and
the battery cell further including:
a first lap weld interconnecting the first laterally extending finger of the first end of the generally U-shaped terminal plate to the first side of the sandwich bar;
a second lap weld interconnecting the second laterally extending finger of the first end of the generally U-shaped terminal plate to the second side of the sandwich bar;
a third lap weld interconnecting the first laterally extending finger of the second end of the generally U-shaped terminal plate to the first side of the sandwich bar; and
a fourth lap weld interconnecting the second laterally extending finger of the second end of the generally U-shaped terminal plate to the second side of the sandwich bar.

13. A vehicle including a battery cell, the battery cell, comprising:
a sandwich bar securing and interconnecting a plurality of electrode tabs and including a welded joint that fuses the plurality of electrode tabs to the sandwich bar, the welded joint extending upward beyond a top surface of the sandwich bar; and
a battery terminal electrically connected, via a weld, to the sandwich bar.

14. The vehicle of claim 13, wherein:
the battery terminal includes a recess formed within a bottom surface thereof; and
the battery terminal is positioned onto the sandwich bar, wherein the welded joint is received within the recess and the bottom surface of the battery terminal is in direct contact with the top surface of the sandwich bar;
the battery cell further including:
a first fillet weld joint interconnecting the top surface of the sandwich bar to the bottom surface of the battery terminal adjacent a first side of the sandwich bar, the first fillet weld joint being a laser weld that is oriented at an angle of between approximately seven degrees and approximately ten degrees relative to the top surface of the sandwich bar and the bottom surface of the battery terminal; and
a second fillet weld joint interconnecting the top surface of the sandwich bar to the bottom surface of the battery terminal adjacent a second side of the sandwich bar, the second fillet weld joint being a laser weld that is oriented at an angle of between approximately seven degrees and approximately ten degrees relative to the top surface of the sandwich bar and the bottom surface of the battery terminal.

15. The vehicle cell of claim 13 including a slot bar positioned between and electrically interconnecting the sandwich bar and the battery terminal, the slot bar including:
a first longitudinal runner positioned adjacent to, in direct contact with and extending along a first side of the sandwich bar and including a first channel formed within an outer surface thereof;
a second longitudinal runner positioned adjacent to, in direct contact with and extending along a second side of the sandwich bar and including a second channel formed within an outer surface thereof;
a first bridge portion interconnecting and extending upward from first distal ends of the first and second longitudinal runners and being received within a first passage within the battery terminal, extending laterally between the first distal ends of the first and second longitudinal runners, and having a first bottom surface that includes a first recess formed therein; and
a second bridge portion interconnecting and extending upward from second distal ends of the first and second longitudinal runners and being received within a second passage within the battery terminal, extending laterally between the second distal ends of the first and second longitudinal runners, and having a second bottom surface that includes a second recess formed therein;
the first and second bridge portions and the first and second longitudinal runners defining a channel, the slot bar positioned onto the sandwich bar, with the sandwich bar positioned within the channel, wherein the welded joint of the sandwich bar is received within the first recess and the second recess and the slot bar is in direct contact with the top surface of the sandwich bar; and
the battery cell further including:
a first lap weld positioned within the first channel formed within the first longitudinal runner and interconnecting the first longitudinal runner to the first side of the sandwich bar; and
a second lap weld positioned within the second channel formed within the second longitudinal runner and interconnecting the second longitudinal runner to the second side of the sandwich bar.

16. The vehicle cell of claim 13 including a slot bar positioned between and electrically interconnecting the sandwich bar and the battery terminal, the slot bar including:
a longitudinal runner positioned adjacent to, in direct contact with and extending along a first side of the sandwich bar and including a channel formed within an outer surface thereof;
a first bridge portion extending upward from a first distal end of the longitudinal runner and being received within a first passage within the battery terminal, extending laterally over the sandwich bar, and having a first bottom surface that includes a first recess formed therein;
a second bridge portion extending upward from a second distal end of the longitudinal runner and being received within a second passage within the battery terminal, extending laterally over the sandwich bar, and having a second bottom surface that includes a second recess formed therein; and
a structural reinforcement extending laterally outward from the longitudinal runner and dividing the channel into a first segment and a second segment;
the slot bar positioned onto the sandwich bar, with the sandwich bar positioned adjacent to and in direct contract with the longitudinal runner, and wherein the welded joint of the sandwich bar is received within the first recess and the second recess and the slot bar is in direct contact with the top surface of the sandwich bar; and
the battery cell further including:
a first lap weld segment positioned within the first segment of the channel and a second lap weld segment positioned within the second segment of the channel, the first and second lap weld segments interconnecting the longitudinal runner to the first side of the sandwich bar.

17. The vehicle cell of claim 13, wherein the battery terminal includes:
a generally U-shaped terminal plate including:
a first end including a flange having a first laterally extending finger positioned adjacent to and in direct contact with a first side of the sandwich bar and a second laterally extending finger positioned adjacent to and in direct contact with a second side of the sandwich bar;
a second end including a flange having first laterally extending finger positioned adjacent to and in direct contact with a first side of the sandwich bar and a second laterally extending finger positioned adjacent to and in direct contact with a second side of the sandwich bar; and
a terminal surface extending laterally between the first and second ends and spaced above the sandwich bar
the battery cell further including:
a first lap weld interconnecting the first laterally extending finger of the first end of the generally U-shaped terminal plate to the first side of the sandwich bar;
a second lap weld interconnecting the second laterally extending finger of the first end of the generally U-shaped terminal plate to the second side of the sandwich bar;
a third lap weld interconnecting the first laterally extending finger of the second end of the generally U-shaped terminal plate to the first side of the sandwich bar; and
a fourth lap weld interconnecting the second laterally extending finger of the second end of the generally U-shaped terminal plate to the second side of the sandwich bar.

18. A method of interconnecting a plurality of electrode tabs of a battery cell to a battery terminal of the battery cell, comprising:
forming a welded joint that fuses a plurality of electrode tabs to a sandwich bar and secures the plurality of electrode tabs therein, wherein, the welded joint extends upward beyond a top surface of the sandwich bar; and
forming a weld that electrically interconnects a battery terminal to the sandwich bar.

19. The method of claim 18, wherein the forming a weld that electrically interconnects the battery terminal to the sandwich bar further includes one of:
positioning the battery terminal onto the sandwich bar, wherein the welded joint is received within a recess formed within a bottom surface of the battery terminal and the bottom surface of the battery terminal is in direct contact with the top surface of the sandwich bar;
laser welding a first fillet weld joint that interconnects the top surface of the sandwich bar to the bottom surface of the battery terminal adjacent a first side of the sandwich bar, wherein the first fillet weld joint is oriented at an angle of between approximately seven degrees and approximately ten degrees relative to the top surface of the sandwich bar and the bottom surface of the battery terminal; and
laser welding a second fillet weld joint that interconnects the top surface of the sandwich bar to the bottom surface of the battery terminal adjacent a second side of the sandwich bar, wherein the second fillet weld joint is oriented at an angle of between approximately seven degrees and approximately ten degrees relative to the top surface of the sandwich bar and the bottom surface of the battery terminal; or
positioning a battery terminal that comprises a generally U-shaped terminal plate onto the sandwich bar, wherein a first end of the generally U-shaped terminal plate includes a flange having a first laterally extending finger positioned adjacent to and in direct contact with a first side of the sandwich bar and a second laterally extending finger positioned adjacent to and in direct contact with a second side of the sandwich bar, and a second end of the generally U-shaped terminal plate includes a flange having a first laterally extending finger positioned adjacent to and in direct contact with a first side of the sandwich bar and a second laterally extending finger positioned adjacent to and in direct contact with a second side of the sandwich bar, and a terminal surface extending laterally between the first and second ends and spaced above the sandwich bar;
laser welding a first lap weld that interconnects the first laterally extending finger of the first end of the generally U-shaped terminal plate to the first side of the sandwich bar;
laser welding a second lap weld that interconnects the second laterally extending finger of the first end of the generally U-shaped terminal plate to the second side of the sandwich bar;
laser welding a third lap weld that interconnects the first laterally extending finger of the second end of the generally U-shaped terminal plate to the first side of the sandwich bar; and
laser welding a fourth lap weld that interconnects the second laterally extending finger of the second end of the generally U-shaped terminal plate to the second side of the sandwich bar.

20. The method of claim 18, wherein the forming a weld that electrically interconnects the battery terminal to the sandwich bar further includes one of:
positioning a two-sided slot bar between and electrically interconnecting the sandwich bar and the battery terminal, wherein the two-sided slot bar includes:
a first longitudinal runner positioned adjacent to, in direct contact with and extending along a first side of the sandwich bar and including a first channel formed within an outer surface thereof;
a second longitudinal runner positioned adjacent to, in direct contact with and extending along a second side of the sandwich bar and including a second channel formed within an outer surface thereof;
a first bridge portion interconnecting and extending upward from first distal ends of the first and second longitudinal runners and being received within a first passage within the battery terminal, extending laterally between the first distal ends of the first and second longitudinal runners, and having a first bottom surface that includes a first recess formed therein; and
a second bridge portion interconnecting and extending upward from second distal ends of the first and second longitudinal runners and being received within a second passage within the battery terminal, extending laterally between the second distal ends of the first and second longitudinal runners, and having a second bottom surface that includes a second recess formed therein;
the first and second bridge portions and the first and second longitudinal runners defining a channel, the two-sided slot bar positioned onto the sandwich bar, with the sandwich bar positioned within the channel, wherein the welded joint of the sandwich bar is received within the first recess and the second recess and the two-sided slot bar is in direct contact with the top surface of the sandwich bar;
laser welding a first lap weld within the first channel formed within the first longitudinal runner and interconnecting the first longitudinal runner to the first side of the sandwich bar; and
laser welding a second lap weld within the second channel formed within the second longitudinal runner and interconnecting the second longitudinal runner to the second side of the sandwich bar; or
positioning a one-sided slot bar between and electrically interconnecting the sandwich bar and the battery terminal, wherein the one-sided slot bar includes:
a longitudinal runner positioned adjacent to, in direct contact with and extending along a first side of the sandwich bar and including a channel formed within an outer surface thereof;
a first bridge portion extending upward from a first distal end of the longitudinal runner and being received within a first passage within the battery terminal, extending laterally over the sandwich bar, and having a first bottom surface that includes a first recess formed therein;
a second bridge portion extending upward from a second distal end of the longitudinal runner and being received within a second passage within the battery terminal, extending laterally over the sandwich bar, and having a second bottom surface that includes a second recess formed therein; and
a structural reinforcement extending laterally outward from the longitudinal runner and dividing the channel into a first segment and a second segment;
the one-sided slot bar positioned onto the sandwich bar, with the sandwich bar positioned adjacent to and in direct contract with the longitudinal runner, and wherein the welded joint of the sandwich bar is received within the first recess and the second recess and the one-sided slot bar is in direct contact with the top surface of the sandwich bar;
laser welding a first lap weld segment within the first segment of the channel and a second lap weld segment within the second segment of the channel, and interconnecting the longitudinal runner to the first side of the sandwich bar.
